(19) United States
(12) Patent Application Publication
(10) Pub. No.: US 2007/0104535 A1
(43) Pub. Date: May 10, 2007

(54) Spline interconnect

(76) Inventor: Brian Valovick, Royal Oak, MI (US)

Correspondence Address: GKN DRIVELINE NORTH AMERICA, INC, 3300 UNIVERSITY DRIVE, AUBURN HILLS, MI, 48326, US

(21) Appl. No.: 11/270,760

(22) Filed: Nov. 9, 2005

(51) Int. Cl. B25G 3/28

(52) U.S. Cl. 403/359.1

(57) ABSTRACT

A first member for transferring torque to a second member of a propshaft assembly includes a splined portion having a plurality of splines. At least one of the plurality of splines includes a pilot spline With a chamber at an end thereof. A height of the pilot spline is greater than a height of the remaining splines. A peak width of the pilot spline is different than a general peak width of the remaining splines, thereby providing a different contact surface area amount between the first member and the second member.

### TECHNICAL FIELD

This invention relates to a spline member assembly and to an interconnection between an internal spline member and an external spline member.

### BACKGROUND

Conventional spline members are implemented in a variety of applications. For example, an internal spline member and an external spline are known to interconnect shaft members. In some applications, the interconnection transfers torque along a shaft and one shaft may be a propeller driveshaft for a vehicle.

With reference to a vehicular application, torque may be transferred along a propeller driveshaft between a transmission and a differential. In an application, a driveshaft may adjust or dynamically compensate for a deviation or the like in a distance between a transmission and an associated differential. Such a deviation in distance may occur, for example, during operation of a vehicle. A known method for accommodating such a change in distance is to telescopically attach or connect an internal spline member to an external spline member. Conventionally, this relationship is known as a slip spline. It is also known to collapsibly connect the shafts. For example, a shaft may be locked and have a collapse threshold that is typically greater than the load of a plungable constant velocity (CV) joint. In an application, a collapse threshold is designed to withstand a pre-defined level of force, and once this threshold is substantially met or exceeded, the shaft is designed to collapse. The collapse threshold may substantially prevent buckling. Conventionally, this relationship is known as a lock spline.

### SUMMARY

The present invention provides a first member for transferring torque to a second member comprising a splined portion having a plurality of splines, at least one of said plurality of splines comprises a pilot spline including a chamfer at an end thereof, wherein a peak width of said pilot spline is different than a general peak width of the remaining splines of said plurality of splines, thereby providing a different contact surface area amount between said first member and said second member.

In another embodiment, a shaft assembly comprises an inner member having an external splined portion, and an outer member having an internal splined portion, said inner member in cooperation with said outer member, wherein at least one of said internal splined portion and said external splined portion includes a pilot spline including a chamfer at an end thereof, wherein a peak width of said pilot spline is different than a general peak width of the remaining splines of said plurality of splines, thereby providing a different surface area amount between said first member and said second member.

In yet another embodiment, a shaft assembly comprises an inner member in cooperation with an outer member, said inner member and said outer member having a first engaging portion and a second engaging portion, at least one of said inner member and said outer member having means for selectively determining a contact surface area between said first engaging portion and said second engaging portion.

The present invention will be more fully understood upon reading the following detailed description in conjunction with the accompanying drawings.

### BRIEF DESCRIPTION OF THE DRAWINGS

The features and inventive aspects of the present invention will become more apparent upon reading the following detailed description, claims, and drawings, of which the following is a brief description:

FIG. 1 shows an exploded view of a shaft assembly according to an embodiment of the invention;

FIG. 2 shows a cross-sectional view of an inner member having an external spline portion taken along the line 2-2 of the shaft assembly of FIG. 1;

FIG. 3 shows an enlarged view of a portion of the spline portion of the inner member of FIG. 2;

FIG. 4 shows a cross-sectional view of an outer member having an internal spline portion taken along the line 4-4 of the shaft assembly of FIG. 1;

FIG. 5 shows an enlarged view of a portion of the spline portion of the outer member of FIG. 4;

FIG. 6 shows an exploded view of a shaft assembly according to an embodiment of the invention;

FIG. 7A shows a cross-sectional view of the shaft assembly taken along the line 7-7 of FIG. 6;

FIG. 7B shows a cross-sectional view of the shaft assembly taken along the line 7-7 of FIG. 6;

FIG. 8 shows a cross-sectional view of the shaft assembly taken along the line 8-8 of FIG. 7;

FIG. 9A shows an enlarged view of a portion of a splined portion; and

FIG. 9B shows an enlarged view of a portion of another splined portion.

### DETAILED DESCRIPTION

Referring now to the drawings, several exemplary embodiments of the invention are shown in detail. Although the drawings represent some embodiments of the invention, the drawings are not necessarily to scale and certain features may be exaggerated to better illustrate and explain the invention. Further, the embodiments set forth herein are not intended to be exhaustive, restrict or otherwise limit the invention to the precise forms and configurations shown in the drawings and disclosed in the following detailed description.

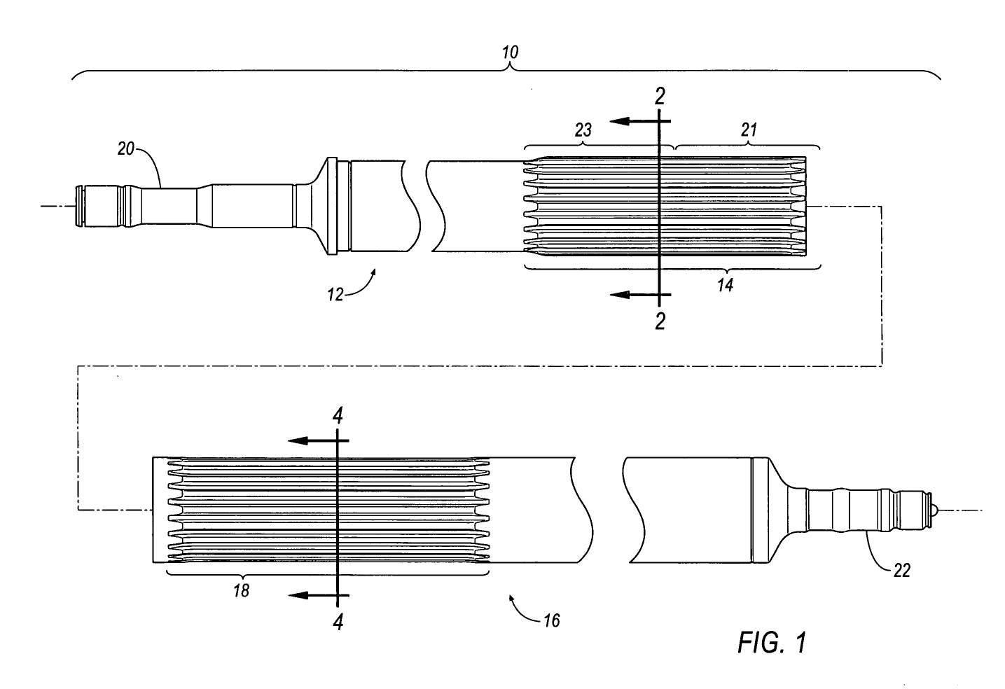

Referring now to FIG. 1, a shaft assembly 10 is shown according to an embodiment of the invention. In general, shaft assembly 10 includes an inner member 12 having an external splined portion 14, and an outer member 16 having an internal splined portion 18. In an embodiment, inner member 12 and outer member 16 may be generally round and/or substantially tubular. In an application, a stub shaft 20 or the like may be fixedly-connected or attached to an end of inner member 12, and a stub shaft 22 may be fixedly-connected or attached to an end of outer member 16. Shaft assembly 10, however, is not limited to the aforementioned fixedly connected or attached stub shafts 20, 22. For example, without limitation, one or both of stub shafts 20, 22 may be replaced with a flange, yoke or other connection-related member. In an embodiment, inner member 12 and outer member 16 may be formed from cylindrical tubes and may be manufactured from any suitable material. If desired, inner member 12 and outer member 16 may be made from commercially available materials, such as, without limitation, low carbon alloy steel, lightweight aluminum or the like. In an embodiment, one or both of the shaft ends may not be fixedly connected or attached to inner member 12 and outer member 16. These and other adjustments to the configuration or possible design modifications will become apparent to one of ordinary skill in the art after considering the present disclosure.

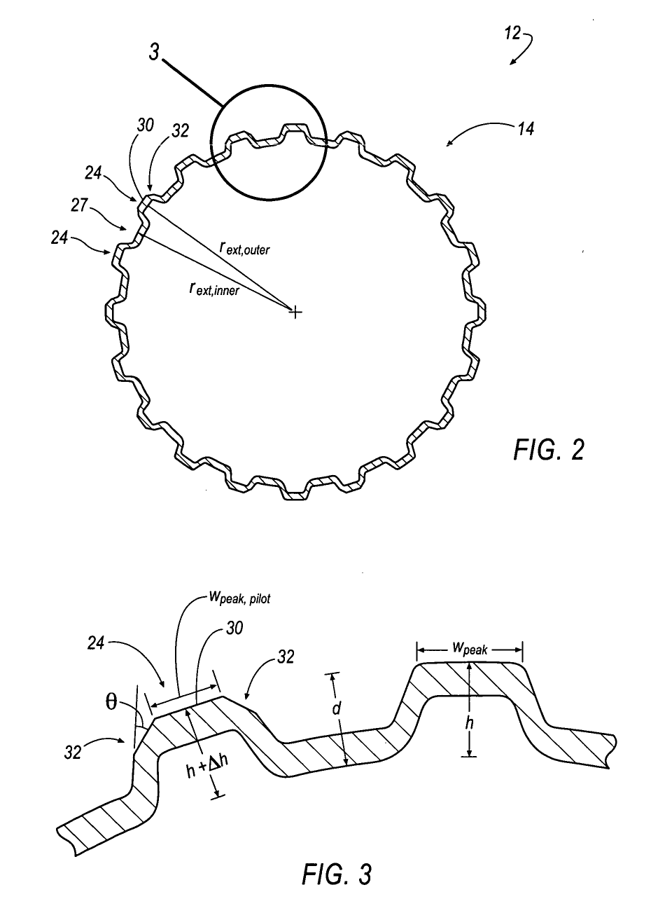

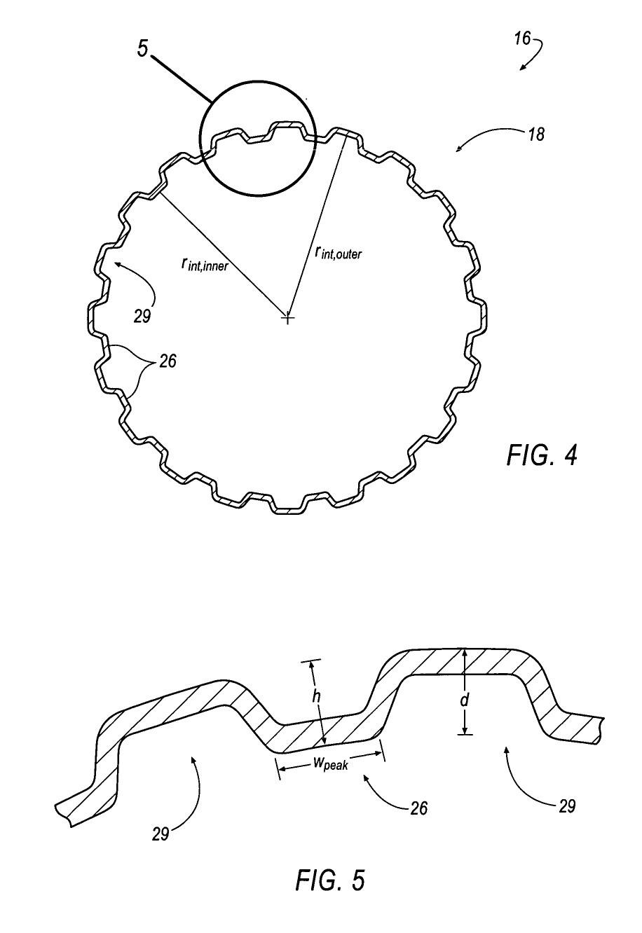

In an embodiment, shaft assembly 10 rotates about an axis to transmit torque. External splined portion 14 of inner member 12 includes a plurality of outwardly projecting splines 24 (See e.g., FIGS. 2 and 3) that are circumferentially formed upon inner member 12. Similarly, internal splined portion 18 of outer member 16 includes a plurality of inwardly projecting splines 26 (see e.g., FIGS. 4 and 5) that are circumferentially formed upon outer member 16.

The splines 24, 26 may be formed using known processes. Such processes will be known to a person of ordinary skill after consulting this disclosure. For example, without limitation, splines 24, 26 can be “cold formed” by the use of the conventional “Grob” process, provided by the Ernst Grob AG Company of Mannedorf, Switzerland. However, the “Grob” process may require a uniform mandrel and a pilot feature to be applied to all teeth. Another process for forming the splines 24, 26 is by deforming the splined portions 14, 18 radially inwardly. Axially forming the splines 24, 26 allow for designs with a varied number of major diameter pilot splines according to the invention to a varied number of spline teeth. Alternatively, portions of splined portions 14, 18 can be expanded radially outwardly.

The splines 24, 26 can also be formed by mechanical crimping, electromagnetic pulse forming, hydroforming, and the like. Electromagnetic pulse forming and hydroforming, for example, can accommodate a varied number of pilot splines according to the invention to a varied number of spline teeth. In addition, a length of the pilot spline can be varied. These and other conventional processes will not be further discussed hereinafter as they are readily known to persons of ordinary skill in the art. As discussed below, in an embodiment the shape and size of the splines 24, 26 may additionally be used to determine the magnitude of the collapse force for shaft assembly 10.

Referring to FIGS. 2 and 3, an embodiment of an exterior surface of inner member 12 includes projections along splined portion 14 that form outwardly projecting (or external) splines 24. A valley or depression 27 is provided between adjacent splines 24. Similarly, with reference to FIGS. 4 and 5, an interior surface of outer member 16 includes projections that form inwardly projecting (or internal) splines 26 that substantially correspond (in circumferential spacing, size, and shape) with depressions 27 of external splined portion 14 of inner member 12. Also, between each inwardly projecting spline, is a valley or depression 29 that substantially corresponds (in circumferential spacing, size, and shape) with splines 24 of inner member 12. A relationship between external splines 24, internal splines 26 and the substantially corresponding depressions 27, 29 will be discussed in further detail below.

The exterior surface of outer member 16 and the interior surface of inner member 12 may additionally include projections and depressions that parallel their opposite surface. For example, without limitation, a depression on an interior surface of inner member 12 may be a projection on the exterior surface of inner member, and vice-versa. Such projections and depressions are sometimes a result of spline forming processes. In another embodiment, at least a portion of one or both exterior surface of outer member 16 and interior surface of inner member 12 may not parallel the opposite surface, and, therefore, the present invention should not be so limited thereby. These and other structural changes will be readily recognizable by one of ordinary skill in the art after consulting the present disclosure without deviating from the intended spirit and scope of the invention.

In an embodiment, one or both of internal splined portion 14 and external splined portion 18 has at least a first portion 21 and a second portion 23. First portion 21 and second portion 23 may be arranged at any position along splined portion 14 and/or 18. For example, if desired, a splined portion may include be two first portions 21 and/or two second portions 23 as the arrangement thereof may be application specific. In an embodiment, first portion 21 contacts a first surface area amount of the corresponding spline portion and second portion 23 contacts a second surface area amount of the corresponding spline portion. In an embodiment, the first and second surface area amounts may be individually described as a summation of the contacted surface areas along each first and second portion 21, 23, respectively, that occur between splined portion 14 of inner member 12 and splined portion 18 of outer member 16. In an embodiment, because the contacted surface amounts may at least affect the amount of radial, axial and/or longitudinal friction exerted between inner member 12 and outer member 16, it may be desirable to structure an interconnection between inner member 12 and outer member 16 to harness or control these and other forces. Thus, by adjusting the total contacted surface area amount (e.g., the first surface area amount plus the second surface area amount) and/or configuring or modifying the arrangement of the first surface area amount with respect to the second surface area amount (i.e., position of first portion 21 and second portion 23) the system may be assembled to provide, inter alia, added longitudinal control when compared to a conventional propeller driveshaft. Specifically, among other examples, varying the amount, or degree, of contacted surface area amounts may affect a plunge of inner member 12 and outer member 16.

In an embodiment utilizing a slip spline relationship between inner member 12 and outer member 16, such that inner member 12 and outer member 16 are telescopically related, contacted surface area amounts may be configured or modified or substantially define or control a plunge relationship between inner member 12 and outer member 16. For example, adjusting the amount of longitudinal friction exerted along various points along inner member 12 and outer member 16 may influence or urge inner member 12 and outer member 16 to a substantially centered position. In an embodiment, increasing the engagement of inner member 12 and outer member 16 along first portion 21 results in an increased amount of longitudinal friction exerted between inner member 12 and outer member 16 as the first surface area amount is greater than the second surface area amount. Thus, plunge of shaft assembly 10 is becomes increasingly prohibited as inner member 12 and outer member 16 increasingly engage along first portion 21. Similarly, the longitudinal friction between inner member 12 and outer member 16 may become reduced as second portion 23 becomes increasingly engaged, and increasing engagement with second portion 23 encourages or facilitates a plunging of inner member 12 and outer member 16. In an embodiment, this feature may be implemented to generally assure a centered shaft assembly. The benefits derived therefrom will be readily recognized by one of ordinary skill in the art.

It should be noted that the structural transition between first portion 21 and second portion 23 may be a gradual slope, a step function or transitions therebetween. The advantages of different transitions will become readily apparent, and may be determined by one of ordinary skill after consulting the present disclosure and considering the particularized application. For example, a sloped transition between second portion 23 and first portion 21 may allow a smoother plunge along the transition, wherein a step function transition may prohibit the plunge therebeyond. Moreover, it should be noted, that at different interfaces along shaft assembly 10, inner member 12 and outer member 16 may engage at both the first portion 21 and the second portion 23, and a longitudinal friction may be a sum of the individual frictions.

In an embodiment enlisting a locked spline relationship between inner member 12 and outer member 16, such that inner member 12 and outer member 16 are substantially longitudinally fixed unless a collapsing force is exerted thereon, contacted first and second surface area amounts may be configured to adjust or substantially define this collapsing force. In an embodiment, a second portion 23 is arranged at one or both ends of a first portion 21, wherein inner member 12 and outer member 16 are, generally, fixedly engaged along first portion 21 unless an external force that sufficiently exceeds the collapsing force therebetween is exerted thereon. Collapsing of shaft assembly 10 aids in preventing the buckling of shaft assembly 10, and absorbs a portion of the external force. Thus, in the event that the collapsing force is met or surpassed by the external force, the first portion 21 and interface between inner member 12 and outer member 16 allow the shaft assembly 10 to substantially collapse. Thus, as second portion 23 becomes engaged due to the collapse, a reduced external force (e.g., below the once satisfied collapse threshold) continues to permit inner member 12 and outer member 16 to collapse and absorb additional external force. Thus, once the collapse of shaft assembly 10 is substantially set in motion, the shaft assembly will generally continue to collapse, in lieu of permitting shaft assembly 10 to buckle.

With reference to the Figures, an embodiment of the invention is illustrated and described wherein an external splined portion 14 of an inner member 12 includes first portion 21 and second portion 23. First portion 21 and second portion 23 of external splined portion 14 are configured to adjust the amount of contacted surface area amounts between external splines 24 and corresponding depressions 29 of outer member 16. The present invention is not limited by the illustrated embodiments. For example, the internal spline portion 18 of outer member 16 may additionally, or instead, include first portion 21 and second portion 23. Also, as mentioned above, there may be more than one first portion 21 and/or second portion 23 as the inclusion thereof may be application specific. This and other features will be discussed in further detail hereinbelow.

Referring now to FIGS. 2 and 3, an embodiment of an external spline 14 of an inner member 12 is shown. External splined portion 14 includes a plurality of outwardly projecting splines 24 with depressions 27 naturally residing therebetween. A floor of depressions 27 defines an inner radius r_{ext,inner} of inner member 12, and, similarly, a peak of outwardly projecting splines 24 defines an outer radius r_{ext,outer} of inner member 12. The outwardly projecting splines 24 have a height, h, measured from the peak of the projection to the inner diameter of tube 12. Similarly, the depressions 27 have a depth d. Splines 24 have a general peak width wₚₑₐₖ measured from a first end of the peak of spline 24 to a second end of the peak of spline 24. In an embodiment, at least outwardly projecting splines 24 contribute to the first and second contact surface area amounts along splined portions 14, 18.

Thus, in an embodiment to substantially configure the second surface area amount, one or more pilot splines 30 may be included among the outwardly projecting splines 24. Each pilot spline 30 has a height, h+Δh, that is greater than the height, h, of the splines 24. Pilot spline 30 may adjust the second contact surface amount by, for example and without limitation, defining a peak width w_{peak,pilot} that is different from the general peak width wₚₑₐₖ. Further details of pilot spline 30 and uses thereof will be further explained below. It should be noted that although a pilot spline 30 is discussed, one of ordinary skill in the art will recognize that other structures or methods may be used along the different portions. For example, a pilot depression, as opposed to pilot spline 30, may be used to adjust the second surface area amount. After considering this disclosure, these and other ways will be immediately apparent to one of ordinary skill and the invention should not be so limited thereby.

In an embodiment, second surface area amount, or, the longitudinal friction exerted between inner member 12 and outer member 16 along the second portion 23, may be adjusted by altering the structure of pilot spline 30. For example, without limitation, reducing or increasing peak width w_{peak,pilot} of pilot spline may reduce or increase the second surface area amount. In an embodiment, peak width w_{peak,pilot} of pilot spline 30 is reduced from the general peak width wₚₑₐₖ by including at least one chamfer at an end of pilot spline 30. Referring to FIG. 3, each end of pilot spline 30 includes a chamfer 32. Chamfer 32 extends at a pre-defined angle θ with respect to its respective end. In an embodiment, chamfer 32 provides exemplary structure to limit the width of the peak of pilot spline 30 w_{peak,pilot} compared to the general peak width wₚₑₐₖ of splines 24. One of ordinary skill will readily recognize other alternatives to reduce the length of the peak, and, similarly will recognize benefits realized by the variations of this angle. It should further be noted that the number of pilot splines may be application specific. These and other features of a pilot spline 26 will be discussed in further detail hereinbelow.

FIGS. 4 and 5 illustrate an embodiment of an internal spline portion 18 of outer member 16 having inwardly projecting splines 26 with depressions 29 therebetween. The floor of the depressions defines an outer radius r_{int,outer} and the peak of inwardly projecting splines 26 defines an inner radius r_{int,inner}. Outer radius r_{ext,outer} of inner member 12 is approximately equal to the inner radius r_{int,inner} of outer member 16.

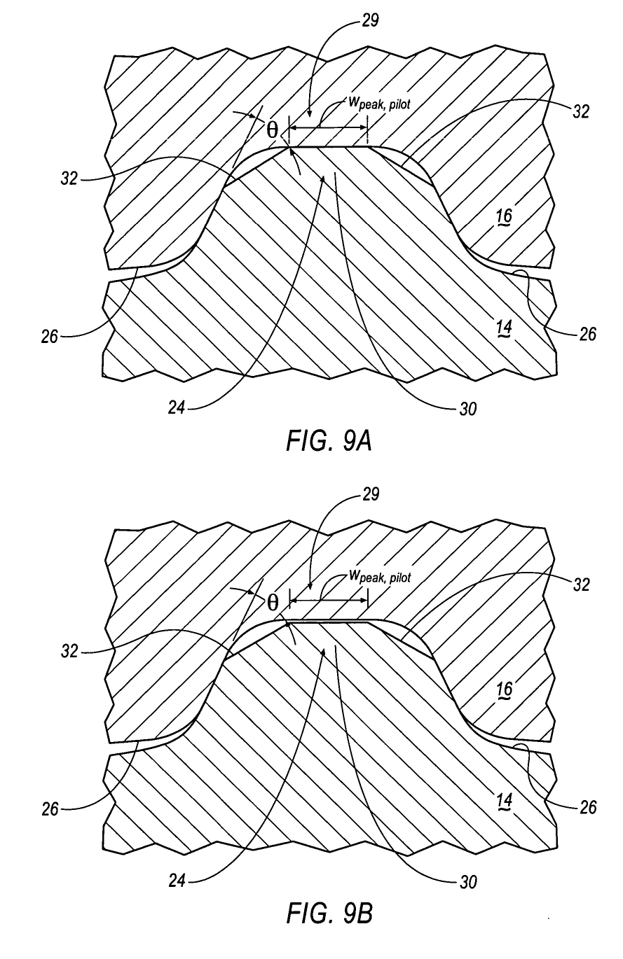

Referring to a locked spline relationship, it should be noted that outer diameter r_{ext,outer} of inner member 12 may be greater than inner radius r_{int,inner} of outer member 16. An embodiment of such a relationship, among other possibilities, is illustrated in FIG. 9A. Thus, as inner member 12 and outer member 16 are combined, it is likely that one or both of inner member 12 and outer member 16 deform to some degree. The force fit and resultant contact between inner member 12 and outer member 16 yields a high first surface area amount, and, thus, a high degree of longitudinal friction is exerted therebetween. This can create a locking effect and a collapse threshold. The collapse threshold is the amount of longitudinal force that effectively meets or exceeds the longitudinal friction. Similarly, it should also be noted that inner radius r_{ext,inner} of inner member 12 may be smaller than outer radius r_{int,outer} of outer member 16, and, in a similar fashion, at least one of inner member 12 and outer member 16 deform to accommodate a size difference.

Referring now to a slip spline relationship, it should be noted that outer radius r_{ext,outer} of inner member 12 may be sized just slightly smaller than inner radius r_{int,inner} of outer member 16. An embodiment of such a relationship, among other possibilities, is illustrated in FIG. 9B. This can create a slip function, such as generally described above. Similarly, it should also be noted that inner radius r_{ext,inner} of inner member 12 may be smaller than outer radius r_{int,outer} of outer member 16. The benefits derived therefrom, and the application specific use therefore will be readily apparent to one of ordinary skill in the art after considering this disclosure. As the pilot feature of the present invention effectively provides structure to control an amount or degree of longitudinal friction between inner member 12 and outer member 16, the radial clearance between the peak of at least one of splines 24, 26 and the floor of depressions 27, 29 may be smaller than convention has previously allowed in slip spline assemblies.

It should be further noted, that the number of splines 24, 26 and depth thereof may application specific to ensure the shaft assembly 10 sufficiently transfers or transmits torque for a particular application. Additionally, the clearance between internally projecting splines 26 and the external spline portion 14 may also be application specific. For example, without limitation, in an embodiment the reduced radial clearance may aid in improving the accuracy of propeller driveshaft balance correction. However, such reductions in radial clearance can sometimes give rise to frictional engagement between component imperfections on interface with minimal clearances, which is addressed by reducing the second contact surface area amount.

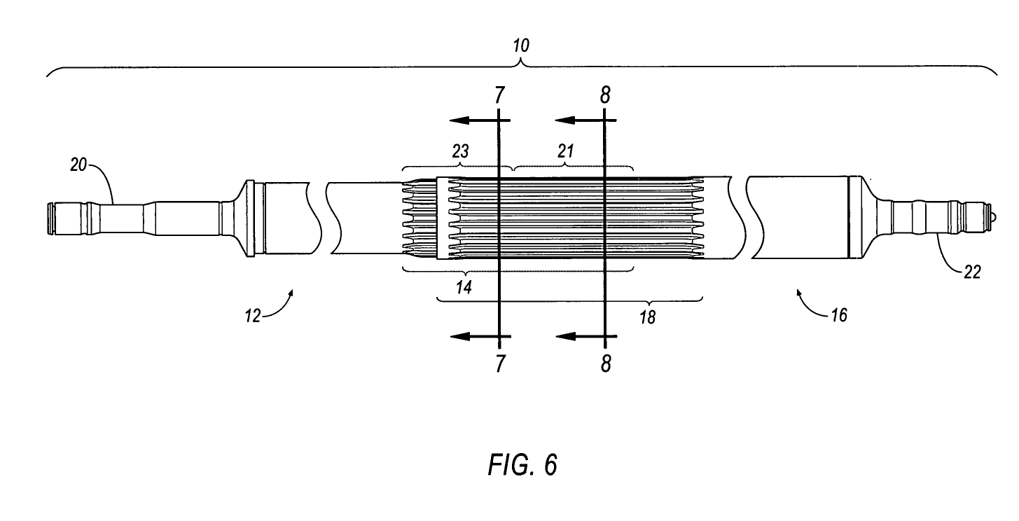

Referring now to the exemplary embodiments shown in FIGS. 6 through 9, inner member 12 is capable of being received within outer member 16 such that the internal splined portion 26 of outer member 16 is adapted to selectively and cooperatively intermesh or engage with the external splined portion 14 of inner member 12.

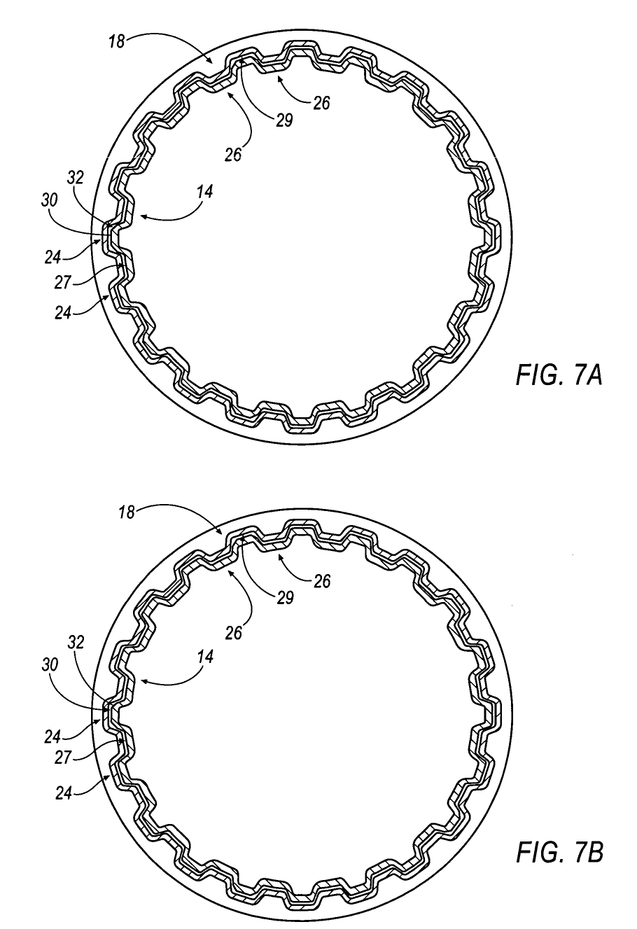

In an embodiment, pilot splines 30 may be symmetrically disposed circumferentially along the splined portion. However, the present invention may also be utilized in a non-symmetric arrangement, and, therefore, should not be limited to the illustrated embodiment. With reference to FIGS. 7A-7B, two exemplary embodiments are shown to highlight some of the various possible pilot spline arrangements along second portion 23. FIG. 7A illustrates inner member 12 having a second portion 23 including pilot splines 30 and conventional splines 24 in an alternating configuration. FIG. 7B illustrates inner member 12 having a second portion 23 wherein every fourth spline 24 is a pilot spline 30. It should be noted that the present invention contemplates any arrangement of pilot splines, and, therefore, the present invention should not be limited to the illustrated embodiments. Also, although each outer member 16 and inner member 12 comprise approximately twenty (20) splines 24, 26 the number and arrangement thereof may be altered in accordance with the present disclosure.

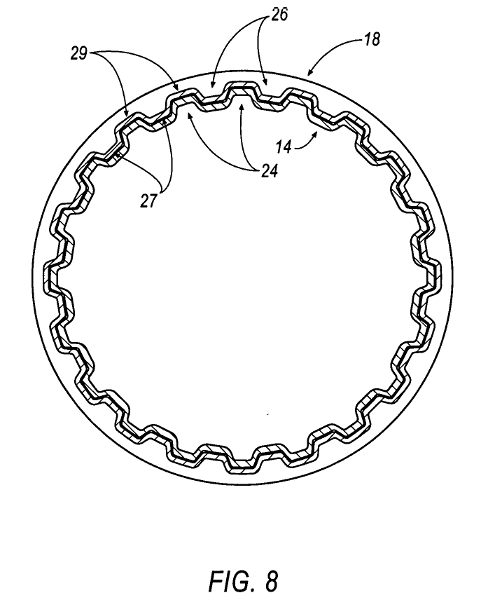

FIG. 8 illustrates an exemplary embodiment of the invention along a segment of first portion 21. The inner member 12 and the outer member 16 are conventionally interconnected and include conventional splines. In the illustrated embodiments of FIG. 7 and FIG. 8, therefore, the first surface area amount along the first portion 21 of FIG. 8 is greater than the second surface area amount along the second portion 23 of FIG. 7. However, altering the organization or number of first portion 21 and second portion 23 will affect the movement of shafts along the splined portions thereof.

FIGS. 9A and 9B illustrate an exploded view of two exemplary interconnections between inner member 12 and outer member 16 along second portion 21 according to an embodiment of the invention. Specifically, FIG. 9A illustrates an embodiment of a lock spline assembly between first member 12 and second member 16 along second portion 23. FIG. 9B illustrates an embodiment of a slip spline assembly between first member 12 and second member 16 along second portion 23. Each configuration has a second surface area amount that is reduced from a first surface area amount, resulting from the inventive addition of second portion 23 and pilot spline 30.

It should be noted that at least a portion of spline portions 14, 18 of one or both of inner member 12 and outer member 16 may be coated with a material having a low coefficient of friction, such as nylon, or the like. The coating can be precision shaved to provide the desired clearance between inner member 12 and outer member 16.

While the invention has been specifically described in connection with certain specific embodiments thereof, it is to be understood that this is by way of illustration and not of limitation, and the scope of the appended claims should be construed as broadly as the prior art will permit.

What is claimed is:

1. A first member for transferring torque to a second member, said first member comprising:
a splined portion having a plurality of splines, at least one of said plurality of splines comprises a pilot spline including a chamfer at an end thereof,
wherein a peak width of said pilot spline is different than a general peak width of the remaining splines of said plurality of splines, thereby providing a different contact surface area amount between said first member and said second member.

2. The first member according to claim 1, wherein the peak width of said pilot spline is smaller than the general peak width of the remaining splines.

3. The first member according to claim 1, wherein said chamfer forms an angle with respect to a side of said pilot spline.

4. The first member according to claim 3, wherein said angle is between about 10 degrees and about 85 degrees.

5. The first member according to claim 1, wherein said pilot spline includes two chamfers.

6. The first member according to claim 5, wherein one of said two chamfers extends from a side of said pilot spline at a first angle and the other of said two chamfers extends from an opposite side of said pilot spline at a second angle.

7. The first member according to claim 6, wherein said first and second angles are substantially equal.

8. The first member according to claim 1, wherein said first member includes a first portion and a second portion.

9. The first member according to claim 8, further comprising a step transition between said first portion and said second portion.

10. The first member according to claim 1, further comprising a plurality of pilot splines, each pilot spline including at least one chamber.

11. A shaft assembly having a plurality of splines, comprising:
an inner member having an external splined portion; and
an outer member having an internal splined portion, said inner member in cooperation with said outer member,
wherein at least one of said internal splined portion and said external splined portion includes a pilot spline including a chamfer at an end thereof, and
wherein a peak width of said pilot spline is different than a general peak width of the remaining splines of said plurality of splines, thereby providing a different surface area amount between said inner member and said outer member.

12. The shaft assembly according to claim 11, wherein said chamfer extends from a side of said at least one pilot spline at an angle.

13. The shaft assembly according to claim 12, wherein said angle is substantially at or between about 10 degrees and about 85 degrees.

14. The shaft assembly according to claim 11, wherein said pilot spline is symmetrically arranged.

15. The shaft assembly according to claim 11, wherein at least a portion of said inner member and at least a portion of said outer member are slidably engaged.

16. The shaft assembly according to claim 11, wherein said pilot spline is adapted to center the shaft assembly in a longitudinal direction.

17. The shaft assembly according to claim 11, wherein said inner member is collapsibly connected to the outer member, the collapsible connection having a collapse threshold defined by a surface area amount between the inner member and the outer member.

18. The shaft assembly member according to claim 11, wherein said inner member moves telescopically with respect to the outer member, and wherein the surface area amount between said inner member and said outer member defines a dynamic plunge relationship between said inner member and said outer member.

19. The shaft assembly according to claim 11, further comprising a plurality of pilot splines, each pilot spline including at least one chamber.

20. The shaft assembly according to claim 11, wherein a height of the pilot spline varies along its length.

21. A shaft assembly, comprising:
an inner member in cooperation with an outer member, said inner member and said outer member having a first engaging portion and a second engaging portion;
at least one of said inner member and said outer member having means for selectively determining a contact surface area between said first engaging portion and said second engaging portion.

22. The shaft assembly according to claim 21, wherein said contact surface area selecting means comprises at least one pilot spline.

23. The shaft assembly according to claim 22, wherein said at least one pilot spline includes at least one chamfer.

24. The shaft assembly according to claim 22, wherein a height of the at least one pilot spline varies along its length.
